(19) United States
(12) Patent Application Publication
(10) Pub. No.: US 2024/0051797 A1
(43) Pub. Date: Feb. 15, 2024

(54) CUTTING TOOL HANDLING ASSEMBLY

(71) Applicant: Chester Brown Industries Pty Ltd, Port Kennedy (AU)

(72) Inventors: Peter Chester, Wannanup, WA (AU); Mordecai Jacobs, Fremantle, WA (AU)

(73) Assignee: Chester Brown Industries Pty Ltd, Port Kennedy (AU)

(21) Appl. No.: 18/279,399

(22) PCT Filed: Mar. 1, 2022
(86) PCT No.: PCT/AU2022/050161

§ 371 Date: Aug. 30, 2023

(30) Foreign Application Priority Data
Mar. 1, 2021 (AU) 2021900546
Jun. 11, 2021 (AU) 2021901759

(51) Int. Cl. B66C 1/42; E21B 12/00

(52) U.S. Cl. CPC B66C 1/42; E21B 12/00

(57) ABSTRACT

There is disclosed a cutting tool handling assembly (10) including a scissor linkage (12) having a lifting end (14) and a cutting tool end (16). The cutting tool handling assembly (10) further includes a tool gripping assembly (26) located at the cutting tool end (26) of the scissor linkage (12). The tool gripping assembly is operatively adapted to grip a cutting tool (17). The cutting tool handling assembly (10) further includes a rotation actuation assembly (18) operatively connected to the scissor linkage (12) at the lifting end (14). The rotation actuation assembly (18), in turn, includes a coupling assembly (20) operatively adapted to couple the scissor linkage (12) to a hoisting assembly.

### FIELD

The invention concerns a cutting tool handling assembly. In one non-exclusive aspect the invention concerns a cutting tool handling assembly for handling drill bits employed in down-the-hole drilling applications.

### BACKGROUND

Down-the-hole drilling (DTH) involves that a drill bit, located at the end of a drill string, be employed to cut rock in the earth's subsurface to create a hole. It is currently the practice that drilling personnel employ an hydraulic crane or a winch cable on a drill tower to lift a drill bit into or from a locking basket proximate the entry to a drilled hole. The drawback of such action is that personnel will be required to handle equipment manually thereby placing their hands in locations where serious injury may be caused by the equipment.

### Object

It is an object of the present invention to address the potential danger of sustaining injury when installing or replacing a cutting tool from a drill string or at least to provide a useful alternative for handling a cutting tool.

### Summary

According to a first aspect of the present invention there is disclosed herein a cutting tool handling assembly including:
a scissor linkage having a lifting end and a cutting tool end;
a tool gripping assembly located at the cutting tool end of the scissor linkage, the tool gripping assembly operatively adapted to grip a cutting tool; and
a rotation actuation assembly operatively connected to the scissor linkage at the lifting end, the rotation actuation assembly including a coupling assembly operatively adapted to couple the scissor linkage to a hoisting assembly, the rotation actuation assembly operatively adapted to cause the scissor linkage to undergo pivotal movement relative to the hoisting assembly, thereby to rotate the cutting tool relative to the hoisting assembly.

Preferably the tool gripping assembly includes a first gripping jaw and a second gripping jaw, the first and second gripping jaws being movable between an open position and a closed position responsive to the scissor linkage being moved between a first position and a second position.

Preferably the scissor linkage includes an actuator operatively adapted to secure the tool gripping assembly in the open position to release the cutting tool from the tool gripping assembly.

Preferably the actuator includes a linear actuator.

Preferably the cutting tool assembly includes a secondary actuator operatively adapted to secure the gripping assembly in the open position.

Preferably the secondary actuator includes a solenoid.

Preferably the rotation actuation assembly includes a motor-gearbox-assembly.

Preferably the scissor linkage includes two opposing protective members operatively associated with an exhaust of a hammer drill bit to be lifted by the tool gripping assembly.

According to a second aspect of the present invention there is disclosed herein a cutting tool handling assembly adapted to handle a drill bit of a down-the-hole drill string, the cutting tool handling assembly including:
a scissor linkage having a lifting end and a cutting tool end;
a tool gripping assembly located at the cutting tool end of the scissor linkage, the tool gripping assembly operatively adapted to grip the drill bit; and
a rotation actuation assembly operatively connected to the scissor linkage at the lifting end, the rotation actuation assembly including a coupling assembly operatively adapted to couple the scissor linkage to a hoisting assembly, the rotation actuation assembly operatively adapted to cause the scissor linkage to undergo pivotal movement relative to the hoisting assembly, thereby to rotate the drill bit relative to the hoisting assembly.

The invention extends to a method of handling a drill bit employed in down-the-hole drilling applications.

### BRIEF DESCRIPTION OF THE DRAWINGS

Preferred embodiments of the invention will be described hereinafter, by way of examples only, with reference to the accompany drawings, wherein:

FIG. 1 is perspective view of a first embodiment cutting tool handling assembly located in position above a cutting tool to be handled, here the cutting tool is a hammer drill bit;

FIG. 2 is a perspective view of the cutting tool handling assembly of FIG. 1 holding the hammer drill bit;

FIG. 3 is a front view of the cutting tool handling assembly of FIG. 1 without any cutting tool being held;

FIG. 4 is a rear view of the cutting tool handling assembly of FIG. 3;

FIG. 5 is a left side view of the cutting tool handling assembly of FIG. 3;

FIG. 6 is a right side view of the cutting tool handling assembly of FIG. 3;

FIG. 7 is a top view of the cutting tool handling assembly of FIG. 3;

FIG. 8 is a bottom view of the cutting tool handling assembly of FIG. 3;

FIG. 9 is a front view of a second embodiment cutting tool handling assembly located in position above a cutting tool to be handled, here the cutting tool is a rotary drill bit;

FIG. 10 is a perspective view of a gripping element of a gripping jaw of the cutting tool handling assembly of FIG. 9;

FIG. 11 is a perspective view of a coupling assembly and a rotation actuation assembly of the cutting tool handling assembly of FIG. 9;

FIG. 12 is a perspective view of a third embodiment cutting tool handling assembly holding a hammer drill bit;

FIG. 13 is a perspective view of the cutting tool handling assembly of FIG. 12 with its casing removed and without the hammer drill bit;

FIG. 14 is a perspective view of a fourth embodiment cutting tool handling assembly holding a rotary drill bit; and

FIG. 15 is a perspective view of the cutting tool handling assembly of FIG. 14 with its casing removed and without the rotary drill bit.

### DESCRIPTION OF PREFERRED EMBODIMENTS

In the description below like reference numerals are employed to indicate like components.

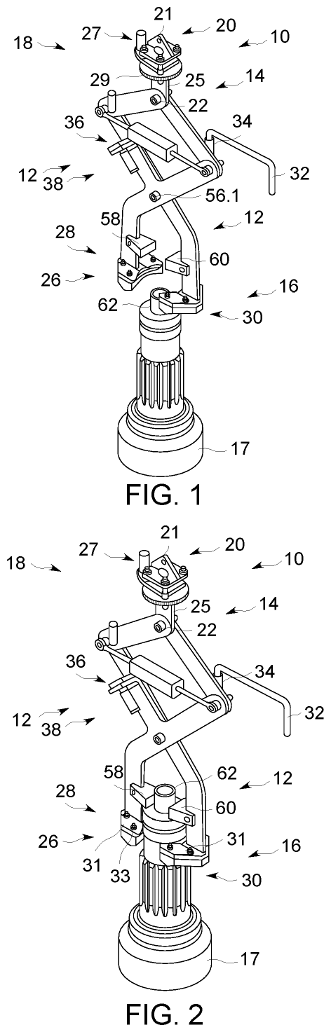

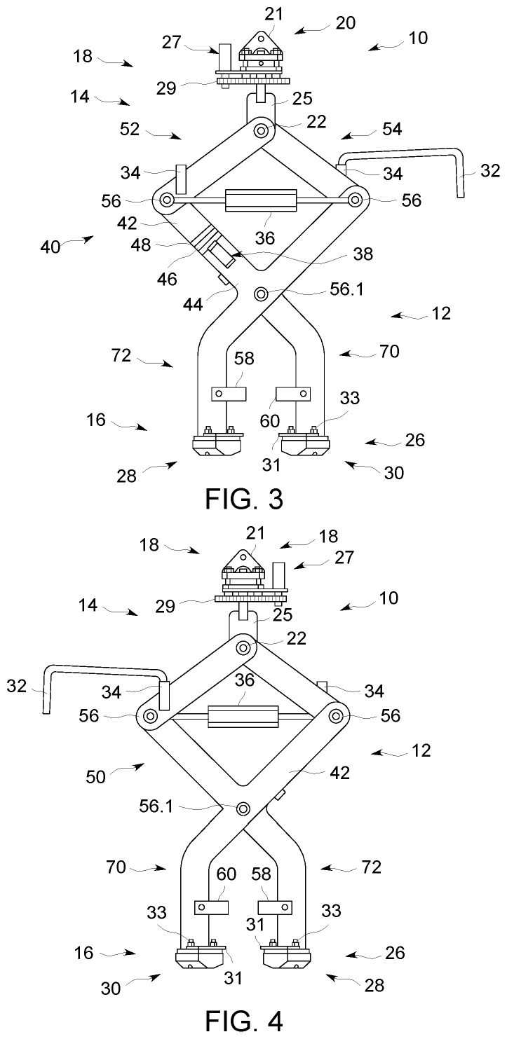

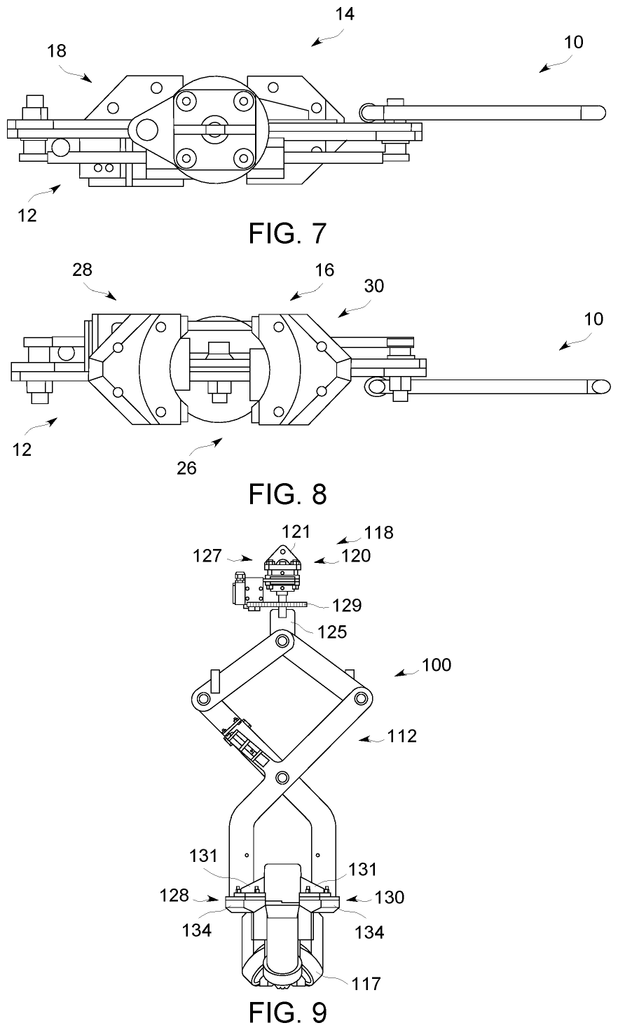

FIGS. 1 to 8 show a first embodiment cutting tool handling assembly, generally indicated with the reference numeral 10. The cutting tool handling assembly 10 includes a scissor linkage 12 having a lifting end 14 and an opposing a cutting tool end 16. The scissor linkage 12 is movable between a non-illustrated first position and second position in the conventional manner in which scissor linkages move to become elongated or retracted. FIGS. 1 and 2 show the cutting tool handling assembly 10 employed to handle a cutting tool 17, here provided in the form of rock hammer drill bit. In use the rock hammer drill bit 17 is coupled to a drilling end of a non-illustrated drill string.

The cutting tool handling assembly 10 includes a rotation actuation assembly 18 located at the lifting end 14 of the scissor linkage 12. The embodiment rotation actuation assembly 18 includes a coupling assembly 20 to facilitate coupling to a non-illustrated hoist. The coupling assembly 20 includes a linkage member 21 via which the coupling assembly 20 is coupled to the non-illustrated hoist.

The rotation actuation assembly 18 further includes a motor-gearbox-assembly 27. The motor-gearbox-assembly 27 is adapted to drive a gear wheel 29. The gear wheel 29, in turn, is coupled to an axle 25. The axle 25 is at one end secured to the coupling assembly 20 via a non-illustrated bearing and to a joint 22 of the scissor linkage 12 at the other end. Activation of the motor-gearbox assembly 27 will induce rotational movement in the axle 25 via the gear wheel 29. As a result of such rotational movement the scissor linkage 12 will be caused to undergo rotational movement relative to the non-illustrated hoist for the purpose described below.

The cutting tool handling assembly 10 further includes a tool gripping assembly 26 located at the cutting tool end 16 of the scissor linkage 12. The tool gripping assembly 26 includes a first gripping jaw 28 and a second gripping jaw 30. The first and second gripping jaws 28, 30 are movable between an open position and a closed position responsive to the scissor linkage 12 being moved between its first and second positions. The first and second gripping jaws 28, 30 are adapted to grip and hold between them outer surfaces of the hammer drill bit 17.

In one exemplary application the cutting tool handling assembly 10 is coupled to a non-illustrated winch of a drill tower and located above the hammer drill bit 17 when the bit is to be lifted and moved to a non-illustrated locking basket. As a winch cable of the winch applies an upward force to the cutting tool handling assembly 10, the scissor linkage 12 will become elongated as it is moved from its first position to a second position. Such movement of the scissor linkage 12 will cause the first and second gripping jaws 28, 30 to move from an open position to a closed position. In the closed position the first and second gripping jaws 28, 30 will grip outer surfaces of the drill bit 17. Continued movement of the scissor linkage 12 from the first position to the second position will cause the first and second gripping jaws 28, 30 to grip the drill bit 17 firmly. Further upward movement of the winch cable will result in the hammer drill bit 17 being lifted so that it can be moved to the locking basket.

As persons skilled in the art will know, a locking basket typically includes a plurality of basket slots operatively associated with complemental drill bit protrusions (not illustrated) on the hammer drill bit 17. To align the drill bit protrusions with the basket slots, the motor-gearbox-assembly 27 is activated by a user operating a non-illustrated control unit. Upon the drill bit protrusions and the basket slots being in register the motor-gearbox assembly 27 is deactivated. The hammer drill bit 17 can now be lowered into the locking basket. It is pointed out that in the case of the motor-gearbox-assembly 27 failing, a handle 32, coupled to the scissor linkage 12 via a tubular member 34, can be manipulated by a user to rotate the scissor linkage 12 so as to locate the hammer drill bit 17 into position to be received by the locking basket.

When the drill bit 17 has been located in position it is required that the tool gripping assembly 26 be located and held in an orientation to enable removal from the drill bit 17. If this orientation is not maintained the scissor linkage 12 will tend to close the tool gripping assembly 26 when an upward force is applied to the scissor linkage 12. For this reason the scissor linkage 12 includes an actuator 36 operatively adapted to move the tool gripping assembly 26 from the closed position to the open position. In this embodiment the actuator 36 is a linear actuator. By providing an actuator/linear actuator 36 an operator may operate the cutting tool handling assembly 10 while seated within a cab of a drilling rig. This feature also enables autonomous operation and obviates the need for an operator to place their hands in a potentially dangerous location.

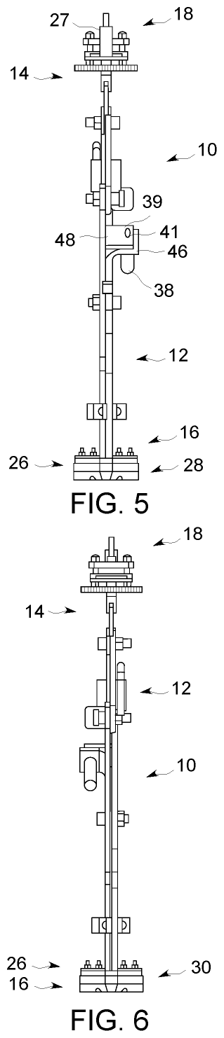

To provide a back-up alterative should the actuator 36 fail, a secondary actuator 38 is provided. The secondary actuator 38 comprises a solenoid assembly mounted to a first lower linkage arm 40 of the scissor linkage 12. The first lower linkage arm 40 includes detachably attachable first and second lower arm members 42, 44 which are adapted to undergo relative movement as the scissor linkage 12 is caused to undergo movement between the first and second positions. The first and second lower arm members 42, 44 respectively include first and second arm flanges 46, 48. The solenoid assembly 38 is secured to the first arm flange 46 while the second arm flange 48 includes a hole 41, show in FIG. 5, adapted to receive a pin 39 of the solenoid assembly 38. Upon the solenoid assembly 38 being activated the pin 39 will locate within the hole 41 of the second arm flange 48. Locating the pin 39 in the hole 41 will prevent relative movement between the first and second arm flanges 46, 48. This, in turn, will result in the scissor linkage 12 maintaining the first and second jaws 28, 30 in the open jaw position. Should the cutting tool assembly 10 be employed at a location without power supply, the solenoid assembly 38 can be replaced with a spring-loaded pin which can be retracted with the use of an appropriate handle.

The scissor linkage 12 includes the first lower linkage arm 40 pivotally connected to a second lower linkage arm 50. The first lower linkage arm 40 is pivotally coupled to a first upper linkage arm 52 which, in turn, is pivotally coupled to a second upper linkage arm 54. The second upper linkage arm 54 is pivotally coupled to a second lower linkage arm 50. The linkage arms 40, 50, 52, 54 are pivotally connected via joints 56.

In this embodiment the first lower arm member 42 is coupled to a first jaw arm 70 which is coupled to the second gripping jaw 30. The second lower linkage arm 50 is coupled to a second jaw arm 72 coupled to the first gripping jaw 28. In this embodiment a first jaw arm 70 is coupled to the first lower arm member 42 while the second jaw arm 72 is coupled to the second lower arm member 44.

It is pointed out that the first and second gripping jaws 28, 30 include jaw gripping elements 31 adapted to be replaced with differently configured gripping elements 31 to accommodate different types of hammer drill bits. Although the gripping elements 31 will have different shapes, they will include bolts holes located in such positions that they all can be secured with the same bolts 33 to the same scissor linkage 12.

The cutting tool handling assembly 10 includes two opposing protective members 58, 60, here provided in the form of high-density polyethylene (HDPE) blocks located between the first and second gripping jaws 28, 30 and the lower joint 56.1 and secured respectively to the first and second jaw arms 70, 72. The purpose of the protective members 58, 60 are two-fold. The first purpose is to protect a PVC exhaust tube 62, shown in FIGS. 1 and 2, of the hammer drill bit 17. The second purpose is to assist in aligning the first and second gripping jaw 28, 30 of the cutting tool handling assembly 10.

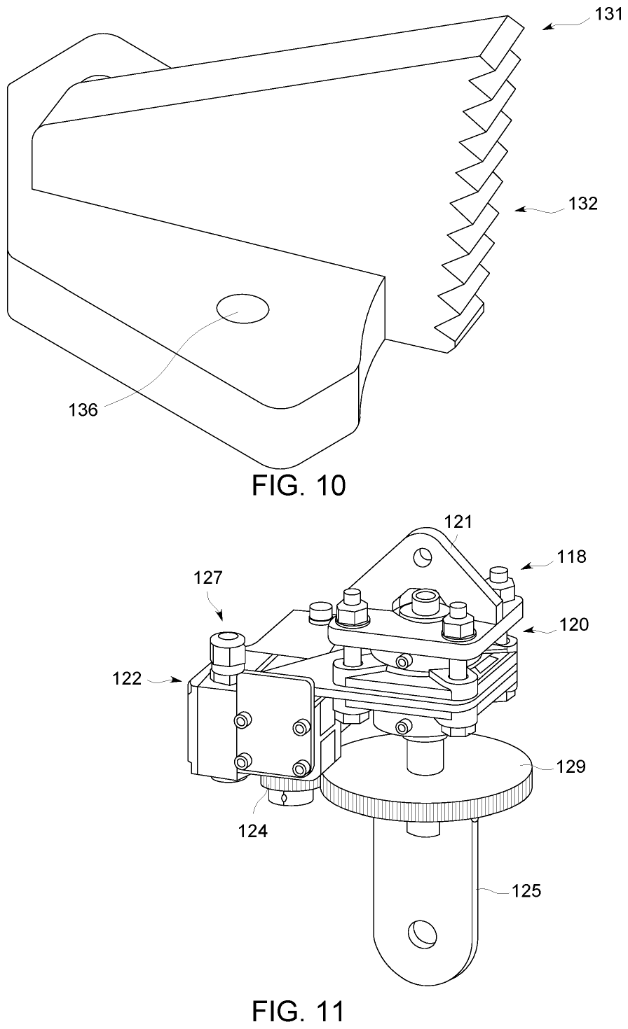

FIG. 9 shows a second embodiment cutting tool handling assembly 100 having a scissor linkage 112 to hold a rotary drill bit 117 secured in position between first and second gripping jaws 128, 130. The cutting tool handling assembly 100 also includes a rotation actuation assembly 118. The first and second gripping jaws 128, 130 include gripping elements 131 produced from aluminium to prevent damage to the threaded portion of a bit. Referring to FIG. 10, the gripping element 131 is produced with a threaded portion 132 matching that of the rotary drill bit 117 being held. Further, the first and second gripping jaws 128, 130 include high-density polyethylene (HDPE) protection members 134 to protect the thread of the bit during operation. The gripping elements 131 include bolt holes 136 through which the gripping elements 131 are secured in position to the first and second gripping jaws 128, 130. Although not shown, the cutting tool handling assembly 100 will typically include a linear actuator similar to that of the first embodiment cutting tool handling assembly 10.

Referring also to FIG. 11, the rotation actuation assembly 118 includes a coupling assembly 120 to facilitate coupling to a non-illustrated hoist. The coupling assembly 120 includes a linkage member 121 via which the coupling assembly 120 is coupled to the non-illustrated hoist. The rotation actuation assembly 118 further includes a motor-gearbox-assembly 127. The motor-gearbox-assembly 127 includes a motor 122 coupled to a driving gear 124 which meshes and operatively drives a gear wheel 129. The gear wheel 129, in turn, is coupled to an axle 125. The axle 125 is at one end secured to the coupling assembly 120 via a non-illustrated bearing and to a joint 119 of the scissor linkage 112 at the other end. Activation of the motor-gearbox assembly 127 will induce rotational movement in the axle 125 via the gear wheel 129. As a result of such rotational movement the scissor linkage 112 will be caused to undergo rotational movement relative to the non-illustrated hoist for the alignment purpose described previously.

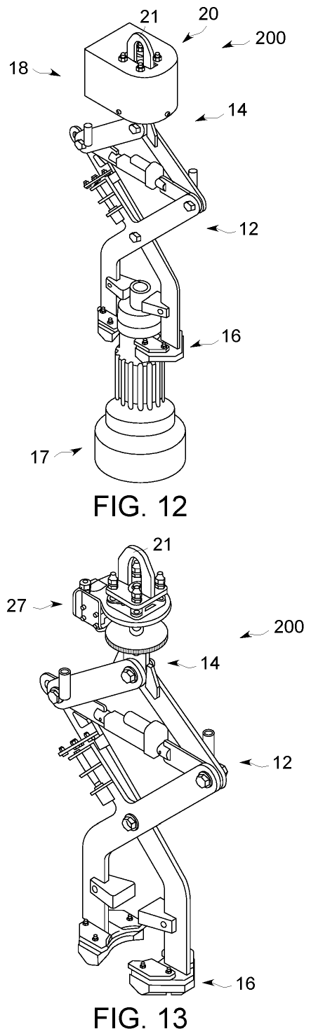

FIGS. 12 and 13 show a third embodiment cutting tool handling assembly 200 holding a rock hammer drill bit 17. The cutting tool handling assembly 200 includes a scissor linkage 12 having a lifting end 14 and an opposing cutting tool end 16. The scissor linkage 12 is movable between a non-illustrated first position and second position in the conventional manner in which scissor linkages move to become elongated or retracted. The cutting tool handling assembly 200 includes a rotation actuation assembly 18 located at the lifting end 14 of the scissor linkage 12. The embodiment rotation actuation assembly 18 includes a coupling assembly 20 to facilitate coupling to a non-illustrated hoist. The coupling assembly 20 includes a linkage member 21 via which the coupling assembly 20 is coupled to the non-illustrated hoist. The rotation actuation assembly 18 includes a motor-gearbox-assembly 27 enclosed within a casing 202. The cutting tool handling assembly 200 operates in a manner similar to the cutting tool handling assembly 10 discussed above.

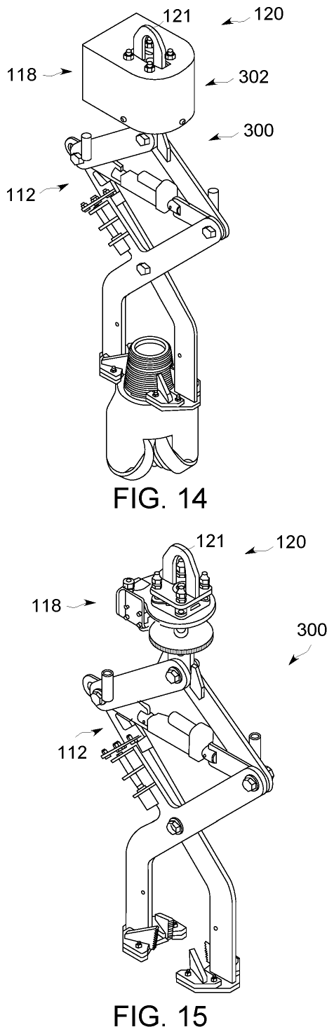

FIGS. 14 and 15 show a fourth embodiment cutting tool handling assembly 300 having a scissor linkage 112 holding a rotary drill bit 117. The cutting tool handling assembly 300 also includes a rotation actuation assembly 118. The rotation actuation assembly 118 includes a coupling assembly 120 to facilitate coupling to a non-illustrated hoist. The coupling assembly 120 includes a linkage member 121 via which the coupling assembly 120 is coupled to the non-illustrated hoist. The rotation actuation assembly 118 further includes a motor-gearbox-assembly 27 which is enclosed within a casing 302. The cutting tool handling assembly 300 operates in a manner similar to the second embodiment cutting tool handling assembly 100 discussed above.

Although the invention has been described with reference to a specific example, it will be appreciated by those skilled in the art that the invention may be embodied in many other forms.

### KEY TO REFERENCE NUMERALS IN DRAWINGS

10 First embodiment cutting tool handling assembly
12 Scissor linkage
14 Lifting end
16 Cutting tool end
17 Hammer drill bit
18 Rotation actuation assembly
20 Coupling assembly
21 Linkage member
22 Joint
25 Axle
26 Tool gripping assembly
27 Motor-gearbox-assembly
28 First gripping jaw
29 Gear wheel
30 Second gripping jaw
31 Gripping element
32 Handle
33 Bolt
34 Tubular member
36 Actuator
38 Secondary actuator/solenoid assembly
39 Pin
40 First lower linkage arm
41 Hole
42 First lower arm member
44 Second lower arm member
46 First arm flange
48 Second arm flange
50 Second lower linkage arm
52 First upper linkage arm
54 Second upper linkage arm
56 Joint
56.1 Lower joint
58, 60 Protective members
62 Exhaust tube
70 First jaw arm
72 Second jaw arm
100 Second embodiment tool handling assembly
112 Scissor linkage
117 Rotary drill bit
118 Rotation actuation assembly
119 Joint
120 Coupling assembly
121 Linkage member
122 Motor
124 Driving gear
125 Axle
127 Motor-gearbox-assembly
128 First gripping jaw
129 Gear wheel
130 Second gripping jaw
131 Gripping element
132 Threaded portion
134 Protection member
136 Bolt hole
200 Third embodiment tool handling assembly
202 Casing
300 Fourth embodiment tool handling assembly
302 Casing

1. A cutting tool handling assembly including:
a scissor linkage having a lifting end and a cutting tool end;
a tool gripping assembly located at the cutting tool end of the scissor linkage, the tool gripping assembly operatively adapted to grip a cutting tool; and
a rotation actuation assembly operatively connected to the scissor linkage at the lifting end, the rotation actuation assembly including a coupling assembly operatively adapted to couple the scissor linkage to a hoisting assembly, the rotation actuation assembly operatively adapted to cause the scissor linkage to undergo pivotal movement relative to the hoisting assembly, thereby to rotate the cutting tool relative to the hoisting assembly.

2. A cutting tool handling assembly according to claim 1, wherein the tool gripping assembly includes a first gripping jaw and a second gripping jaw, the first and second gripping jaws being movable between an open position and a closed position responsive to the scissor linkage being moved between a first position and a second position.

3. A cutting tool handling assembly according to claim 2, wherein the scissor linkage includes an actuator operatively adapted to secure the tool gripping assembly in the open position to release the cutting tool from the tool gripping assembly.

4. A cutting tool handling assembly according to claim 3, wherein the actuator includes a linear actuator.

5. A cutting tool handling assembly according to claim 4, including a secondary actuator operatively adapted to secure the gripping assembly in the open position.

6. A cutting tool handling assembly according to claim 5, wherein the secondary actuator includes a solenoid.

7. A cutting tool handling assembly according to claim 1, wherein the rotation actuation assembly includes a motor-gearbox-assembly.

8. A cutting tool handling assembly according to claim 1, wherein the cutting tool is a hammer drill bit

9. A cutting tool handling assembly according to claim 8, wherein the scissor linkage includes two opposing protective members operatively associated with an exhaust of the hammer drill bit to be lifted by the tool gripping assembly.

10. A cutting tool handling assembly according to claim 1, wherein the cutting tool is a rotary drill bit.

11. A cutting tool handling assembly adapted to handle a drill bit of a down-the-hole drill string, the cutting tool handling assembly including:
a scissor linkage having a lifting end and a cutting tool end;
a tool gripping assembly located at the cutting tool end of the scissor linkage, the tool gripping assembly operatively adapted to grip the drill bit; and
a rotation actuation assembly operatively connected to the scissor linkage at the lifting end, the rotation actuation assembly including a coupling assembly operatively adapted to couple the scissor linkage to a hoisting assembly, the rotation actuation assembly operatively adapted to cause the scissor linkage to undergo pivotal movement relative to the hoisting assembly, thereby to rotate the drill bit relative to the hoisting assembly.
